(19) United States
(12) Patent Application Publication
(10) Pub. No.: US 2011/0035074 A1
(43) Pub. Date: Feb. 10, 2011

(54) Remote controlled power consuming device and module therefore

(75) Inventors: Andrew Charles Davison, Harrisburg, PA (US); John Eugene Westman, Harrisburg, PA (US); Steven Lee Flickinger, Hummelstown, PA (US)

Correspondence Address: TYCO TECHNOLOGY RESOURCES, 4550 NEW LINDEN HILLS ROAD, SUITE 140, WILMINGTON, DE, 19808, US

(73) Assignee: Tyco Electronics Corporation, Berwyn, PA (US)

(21) Appl. No.: 12/462,552

(22) Filed: Aug. 5, 2009

(51) Int. Cl. G06F 1/26; G06F 15/16

(52) U.S. Cl. 700/295; 709/230; 340/310.11

(57) ABSTRACT

A power consuming device having communication with a utility company is disclosed. A power consuming device enclosure is described which has an interface and a communication module. The module includes a standardizing chip in communication with a communication interface, a protocol chip in communication with the standardizing chip. The communication could be by way of a protocol antenna, for receiving (and transmitting: i.e. the appliance can talk to the power company as well as receive communication from the power company) wireless protocol signals and transmitting the signals to the protocol chip.

### BACKGROUND

The subject disclosure relates to energy consuming devices and their controls.

Many different types of power consuming devices exist in the home, some of which are referred to as home appliances, which could include kitchen appliances such as refrigerators, stoves, dishwashers, freezers and the like. Other power consuming home devices include items such as washers and dryers, hot water heaters, lighting, HVAC, etc. Most of these devices have cycles which incur large electrical power usage yet could be completed at times discretionary to the homeowner. For example, refrigerators and freezers have automatically run defrost cycles, and many ovens have automatically operated oven cleaning cycles. In other instances, the cycle itself could be discretionary to the homeowner, for example the operation of washers/dryers and dishwashers could have delayed start features.

The reason that the start/run times for these appliances is relevant, is that the energy costs vary during the day due to the electrical demand or load. Electricity is sold in increments known as KW-hrs. and during peak times of the day, the cost per KW-hr is the highest. Other times, for example at nights/weekends, the cost per KW-hr decreases, sometimes substantially, in the range of 20-50% less than on-peak costs. However, the consumer has no clear indication of when the on-peak/off-peak times are; in fact most consumers do not know the difference in the cost.

It would be advantageous if home appliances could “talk” to the utility companies and know when the on-peak/off-peak times are, such that discretionary functions could be operated during the off-peak times. This communication could be done wirelessly, or it could be done by communication into the device, for example over the power lines. This could be advantageous to both the consumer and the power company. The appliance/device communication could also be used so that the customer can access the controls of their appliance/device while not at home (i.e. changing the temperature on a thermostat remotely from a smart phone or other internet capable device).

In peak times, “brown-outs” or “black-outs” have occurred because of the overload on the power grids. If the power company had control back to the power consuming device, the company could back down or delay levels of power to certain functions remotely. Consumers eventually pay less, as utility companies can forego building further power generation plants.

Networks and/or their protocols exist, but not for the aforestated purpose. For example, one of the first wireless protocols for home automation was known as the X-10 protocol. Newer protocols include such wireless protocols as Zigbee, Z-wave, Bluetooth and/or Wi-Fi. Signal over power networks include LonWorks available from Echelon Corporation at 550 Meridian Ave., San Jose, Calif. 95126.

### SUMMARY

In one embodiment disclosed herein, a power consuming device comprises a device enclosure, and a communication module profiled for receiving communication signals, where the module comprises a standardizing chip in communication with the communication interface and a protocol chip for receiving the communication signals in a network protocol and for communication with the standardizing chip.

In another embodiment, a communication module is disclosed for interfacing with a public utility company and controlling discretionary functions of a power consuming device. The module comprises a standardizing chip in communication with the power consuming device, a protocol chip in communication with the standardizing chip, and a communication input for receiving protocol signals and transmitting the signals to the protocol chip.

In yet another embodiment, a communication assembly is disclosed for interfacing with a public utility company and controlling discretionary functions of a power consuming device. The assembly comprises a pluggable module comprising an electronic device having control means for inputting the utility company signals and supplying communication signals to be read by the appliance. The assembly further comprises an interface for positioning on or adjacent to the device, and for electrical connection to the device controls, the interface being connectable with the module.

### BRIEF DESCRIPTION OF THE DRAWINGS

FIG. 1 shows a diagrammatical depiction of a utility company and a wirelessly controlled energy consuming device;

FIG. 2 shows a perspective view of a communication assembly;

FIG. 3 shows the communication assembly of FIG. 2 as comprised of a communication module and a module interface;

FIG. 4 shows the outer housing of the communication module;

FIG. 5 shows a top plan view of the outer housing of FIG. 4;

FIG. 6 shows a perspective view of the control board of a wireless module; and

FIG. 7 shows an alternate diagrammatical depiction of a utility company and an energy consuming device which is controlled by signals transmitted over the power lines.

### DETAILED DESCRIPTION OF THE EMBODIMENT

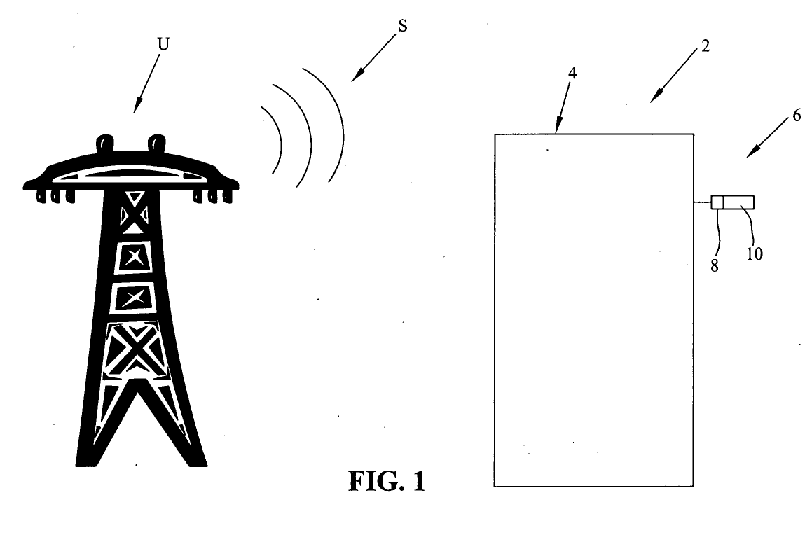

With respect to FIG. 1, a remotely controlled energy consuming device is shown at 2 comprised of a power consuming device enclosure 4 and a communication assembly 6. The device 4 could be controlled wirelessly or could be controlled by signals over the power line. With respect first to FIG. 1, the wireless configuration will be described first.

Wireless communication assembly 6 is comprised of an interface 8 and a communication module 10. The device enclosure 4 could be any number of appliances such as home appliances: refrigerators, deep freezers, washing machines and dryers, dishwashers, microwaves, hot water heaters, and the like. While the wireless communication assembly 6 is shown in FIG. 1 diagrammatically, it is contemplated that the assembly 6 would be placed on the enclosure 4, where the interface 8 is accessible, but not necessary visible to the eye. For example, on a refrigerator, the back wall could be used to mount the interface, and the module could be inserted, and then the refrigerator pushed towards a rear wall.

As also shown in FIG. 1, a utility company is shown as “U” which sends signals “S” to be read by the assembly 6. While FIG. 1 shows the signals S being sent by the utility company U, it is contemplated that the signal emitter would be placed on or about the residence by the utility company U, for example at or in conjunction with the electrical meter, with wireless signal being sent from a position proximate the residence.

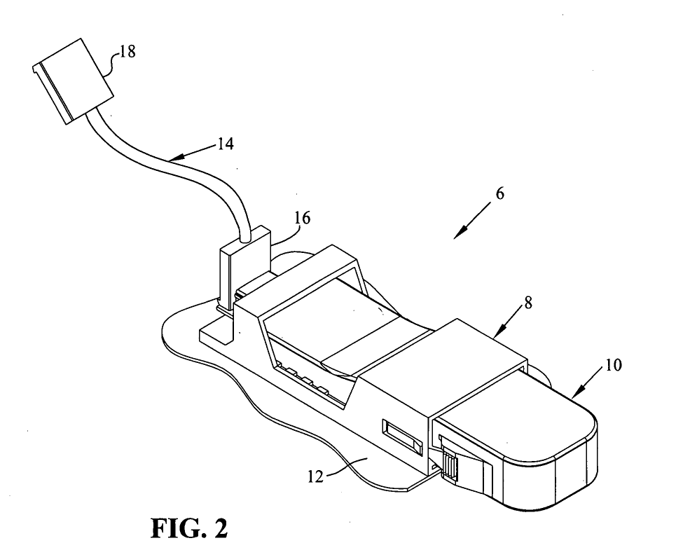

With reference now to FIG. 2, wireless communication assembly is shown at 6 to include wireless module interface 8 and wireless communication module 10. Wireless module interface 8 is shown attached to a wall 12, which could be a structural wall of the home, or could be a wall of the device enclosure as discussed above. Wireless interface would include a wire harness 14 having a first connector 16 connected to the wireless interface and a second connector 18 connected to a control module (not shown) of the device enclosure 4. The assembly could also be directly attached to the device's control board (PCB) in which case the wire harness would not be used.

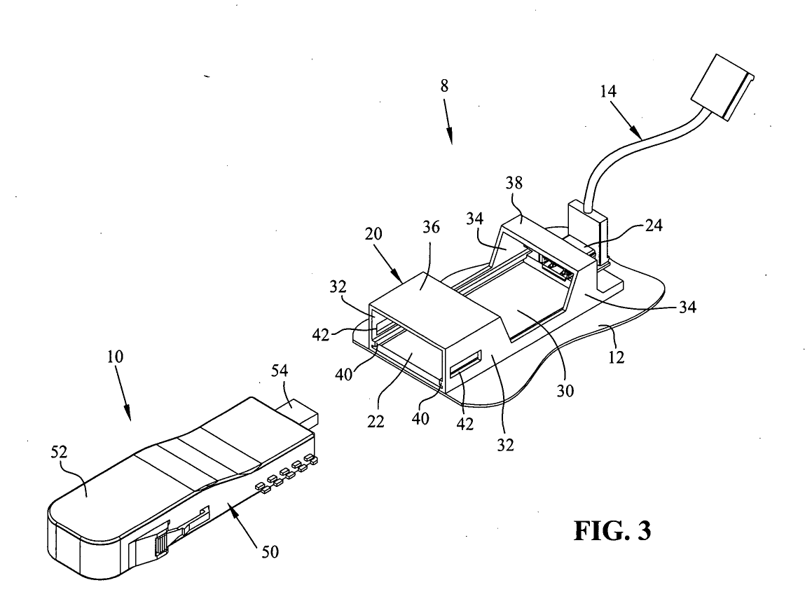

As shown in FIG. 3, interface 8 comprises a receptacle housing 20 having an opening at 22, and a connector socket 24 positioned at an inner end of the receptacle housing 20. Connector socket 24 is then electrically connected to harness by a pin header, as is known in the art. Receptacle housing 20 is comprised of a bottom mounting wall 30, sidewalls 32, 34, and top walls 36, 38. Side walls 32, 34 include alignment ribs 40 running along the length as described herein, and latch openings at 42.

Wireless communication module 10 is comprised of an outer housing 50 and a cover 52. Module 10 would include an electrical connector 54, complementary with socket 24 for transmitting signals thereto. The assembly of the socket 24 and connector 54 could take any form of mating configuration, for example the configuration could be that of a USB or micro-USB profile, or any other mating configuration.

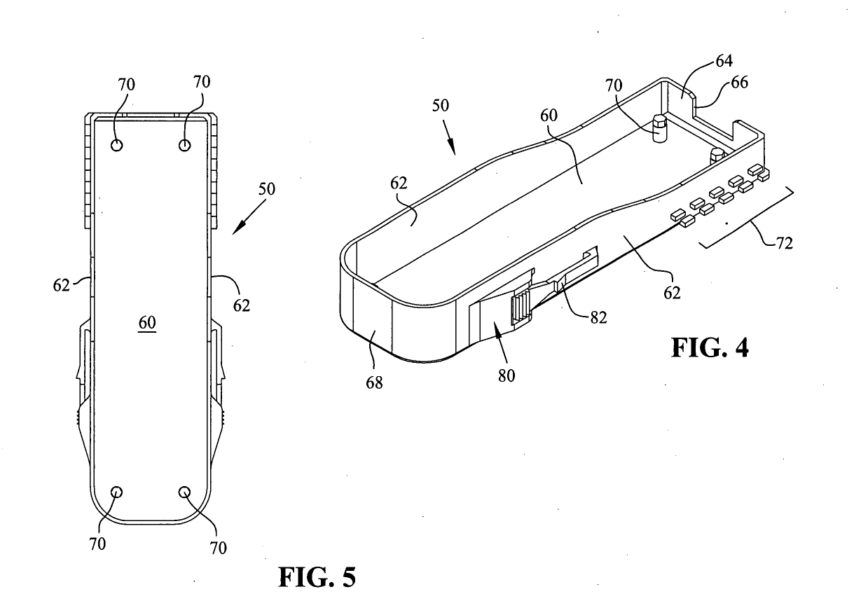

Housing 50 is shown better in FIGS. 4 and 5 as comprised of lower wall 60, sidewalls 62, end wall 64 having opening 66, and end wall 68. Lower wall 60 has mounting posts 70 for mounting a communication board as further described herein. Sidewalls 62 include alignment members 72, shown here as two rows of staggered lugs, which receive ribs 40 therebetween. Sidewalls 62 also include latches 80 having catches 82 which cooperate with openings 42 (FIG. 3).

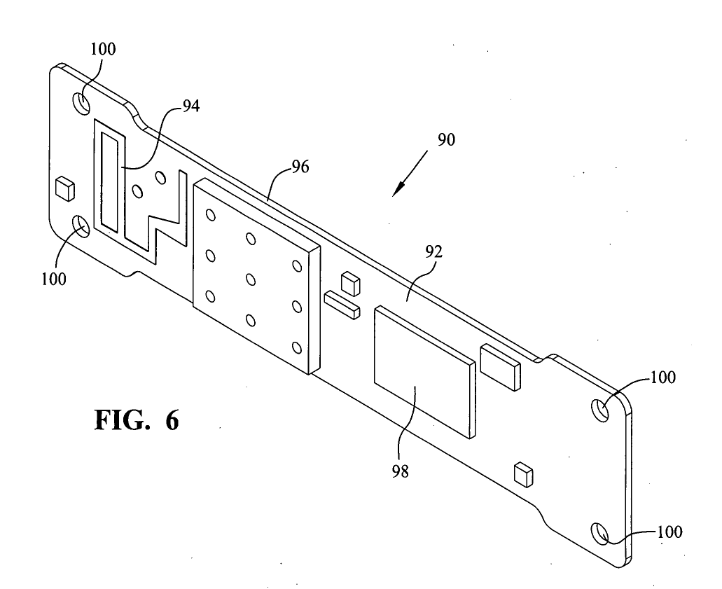

With reference now to FIG. 6, a communication board or card 90 is shown which is receivable in housing 50. Communication board 90 comprises a printed circuit board 92, an RF antenna 94, an RF chip 96, and a standardizing chip 98. Board 92 includes apertures 100, in a like profile as mounting posts 70. Mounting posts 70 could be threaded bosses which receive a threaded fastener for attaching the board 90, or could be heat-stake posts for attaching board 90.

As shown, antenna 94 is directly integrated with the board 92, for example as described in U.S. Pat. No. 6,087,972, the subject matter which is disclosed herein by reference. Antenna 94 would be in direct communication with chip 96. Chip 96 is referred herein as either an RF chip or as a protocol chip. Chip 96 would be specific to a wireless protocol language, for example Zigbee protocol. The protocol would be chosen by the utility company in the format in which it chooses to communicate. Chips specific to various protocols already exist; for example chips in Zigbee protocol are available from Atmel Corporation of San Jose, Calif., or from Texas Instruments of Dallas, Tex.

Chip 98 is referred to as a standardizing chip. It functions to take the protocol of the chip 96 and standardize it to the control language of the specific device. Thus, multiple module combinations are contemplated as the protocol chosen by the utility company varies, as does the control language chosen by the specific device manufacturer. Thus, the standardizing chip 98 may be specific to the protocol and device control language, or the standardizing chip may be the same across all assemblies. The standardizing chip could be of the type available from Archtech Electronics Corp., of 117A Docks Corner Rd., Dayton, N.J. 08810

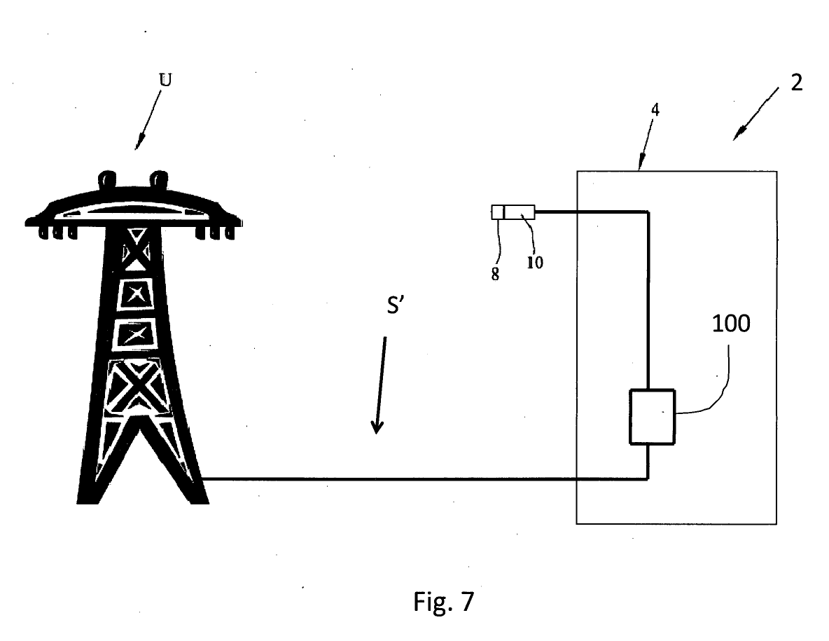

Alternatively and referring now to FIG. 7, the communication from the utility company U could be made by way of signals S′ directly over the power line. In this case the signals would be communicated directly to the device control board 100 and the communication signals would be received through the interface 8 to the module 10, and then back to the control board through the standardizing chip 98. In this case, the module 10 need not have the antenna, but may be included for redundancy, or for simplicity of manufacturing. The power company to device communication may be accomplished in at least 4 ways:

Power Company to home=wired; Home to device=wired

Power Company to home=wired; Home to device=wireless

Power Company to home=wireless; Home to device=wired

Power Company to home=wireless; Home to device=wireless

Also alternatively, the antenna need not be part of the communication module 10. For example, in the event where the interface is embedded within the energy consuming device enclosure 4, the module may be shielded from wireless signals. Thus an external antenna is also contemplated, where the antenna is mounted external to the device. Furthermore, in the event of a densely populated residential area, for example an apartment building, a single antenna could be provided for plural communication modules with encrypted signals. Furthermore, the signal over power lines does not have to go through a communication module 10; it could go straight to the electrical device through the power running throughout the house.

Thus, each energy consuming device manufacturer could include an interface 8 having an industry standardized socket profile, for example USB or micro-USB. The modules 10 are then provided by the utility company, by the device manufacturer, or by a third party specifically designed to match the utility company protocol and the control language of the device manufacturer.

While this invention has been described as having an exemplary design, the present invention may be further modified within the spirit and scope of this disclosure. The application is, therefore, intended to cover any variations, uses, or adaptations of the invention using its general principles. Further, this application is intended to cover such departures from the present disclosure as come within known or customary practice in the art to which this invention pertains.

What is claimed is:

1. A power consuming device having communication input, comprising:
a power consuming device enclosure;
a communication module profiled for receiving communication signals, the module comprising:
a standardizing chip in communication with the power consuming device;
a protocol chip for receiving the communication signals in a network protocol and for communication with the standardizing chip.

2. The power consuming device of claim 1, wherein the communication signals are received wirelessly.

3. The power consuming device of claim 2, further comprising a protocol antenna, for receiving wireless protocol signals and transmitting the signals to the protocol chip.

4. The power consuming device of claim 1, wherein the communication signals are received through a power line.

5. The power consuming device of claim 3, wherein the protocol for the protocol chip and protocol antenna is one from the group comprised of Zigbee, Z-wave, X-10, Bluetooth or Wi-Fi.

6. The power consuming device of claim 3, wherein the protocol chip and the protocol antenna are housed in communication module and the communication module is pluggable.

7. The power consuming device of claim 6, further comprising a communication interface positioned on or adjacent to the device enclosure for interfacing with the pluggable module.

8. The power consuming device of claim 7, wherein the communication interface is a standardized port.

9. The power consuming device of claim 3, wherein the protocol antenna is an RF antenna.

10. The power consuming device of claim 3, wherein the protocol antenna can receive signals from a utility company to regulate the discretionary functions of the power consuming device.

11. A communication module for interfacing with a public utility company and controlling discretionary functions of a power consuming device, comprising:
a standardizing chip in communication with the power consuming device;
a protocol chip in communication with the standardizing chip; and
a communication input for receiving protocol signals and transmitting the signals to the protocol chip.

12. The communication module of claim 11, wherein the communication input is a wireless input.

13. The communication module of claim 12, wherein the wireless input is a wireless antenna.

14. The communication module of claim 13, wherein the protocol for the protocol chip and protocol antenna is one from the group comprised of Zigbee, Z-wave, X-10, Bluetooth or Wi-Fi.

15. The communication module of claim 13, wherein the protocol chip and the protocol antenna are housed in a pluggable module.

16. The communication module of claim 15, further comprising a communication interface positioned on the pluggable module.

17. The communication module of claim 11, wherein the protocol antenna is an RF antenna.

18. A communication assembly for interfacing with a public utility company and controlling discretionary functions of a power consuming device, comprising:
a pluggable module comprising an electronic device having control means for inputting the utility company signals and supplying communication signals to be read by the power consuming device;
an interface for positioning on or adjacent to the power consuming device, and for electrical connection to the power consuming device controls, the interface being connectable with the module.

19. The communication assembly of claim 18 wherein the module further comprises a protocol antenna and the utility company signals are wirelessly read by the protocol antenna.

20. The communication assembly of claim 19, wherein the control means is comprised of a protocol chip in communication with the protocol antenna, a standardizing chip in communication with the protocol chip and the device, the protocol antenna receiving signals from the utility company and communicating those signals to the protocol chip and feeding those signals to the standardizing chip, the standardizing chip relaying readable signals for a specific device.
